(19) United States
(12) Patent Application Publication
(10) Pub. No.: US 2003/0122317 A1
(43) Pub. Date: Jul. 3, 2003

(54) Method for manufacturing an elastic sealing ring and sealing ring manufactured according to the method

(76) Inventor: Thomas Andersson, Kungsor (SE)

Correspondence Address: Sughrue Mion, 2100 Pennsylvania Avenue NW, Washington, DC, 20037-3213, US

(21) Appl. No.: 10/276,826

(22) PCT Filed: May 18, 2001
(86) PCT No.: PCT/SE01/01113

(30) Foreign Application Priority Data
May 19, 2000 (SE) 0001874-7

(51) Int. Cl. F02F 5/00

(52) U.S. Cl. 277/440; 264/241; 277/434

(57) ABSTRACT

Elastic sealing ring for sealing between a displaceable and/or rotatable component, such as a piston (2), piston rod (3), shaft etc., and a surrounding component, such as a cylinder block (1), a cylinder end wall etc. The sealing ring is adapted so as to be mounted in a groove in one component and has at least one sealing surface (28; 31, 32) intended for bearing against the other component, and comprises two materials with different properties. The sealing ring is made with an inner injection-molded core (17) made of a first material with first properties and an outer layer (18) made of a second material with in part second properties and injection-molded together with the core. This material is fused together with the material in the core in the boundary zone. The sealing surface is at least partly formed by a part of the outer layer (18), which has lower friction on contact with a component part bearing against it than the material in the core (17). The invention also relates to a method for manufacturing a sealing ring as above.

### FIELD OF THE INVENTION

The present invention relates to a method for manufacturing an elastic sealing ring for sealing between a displaceable and/or rotatable component, such as a piston, piston rod, shaft etc., and a surrounding component, such as a cylinder block, a cylinder end wall etc., which sealing ring is adapted so as to be mounted in a groove in one component and has at least one sealing surface intended for bearing against the other component.

The invention also relates to an elastic sealing ring manufactured by means of the method according to the invention.

### BACKGROUND OF THE INVENTION

Sealing rings of the type indicated above are used in many situations, inter alia as hydraulic seals for pistons and piston rods. One application is as a wiper for piston rods, their task being to prevent dirt or other impurities from, for example, accompanying a piston rod into a hydraulic cylinder. They can also be used on rotating shafts which may be, for example, axially displaceable.

Another application is as a pressure seal between a piston rod and a cylinder end wall in order to prevent leakage of pressure fluid from the cylinder. A similar application is as a piston seal in order to bring about sealing between a displaceable piston and a surrounding cylinder block.

Piston rod wipers and pressure seals for piston rods are commonly used together. Conventionally, however, they have been made and mounted as two separate components. One of the reasons for this is that an elastic sealing ring, which is usually made of polyurethane, must be so soft/elastic that good sealing and bearing against the piston rod are obtained. A disadvantage of this is that the risk of gap extrusion, that is to say material being forced out into the gap between the two components which are to be sealed relative to one another, is relatively great. As the entire seal body is also made of the same relatively elastic material, the friction against the piston rod increases, the temperature in the seal material then increasing, which in turn reduces the rigidity and brings about a further increase in friction and temperature, and so forth.

In order to prevent gap extrusion, pressure seals for piston rods and piston seals are supplemented by support rings made of relatively hard plastic material, which prevent the soft polyurethane seal material being forced out into the gap. This makes manufacture, mounting and maintenance more expensive and complicated.

In wipers for piston rods, the sealing rings serving as wipers have commonly been provided with a sheet-metal surround in order to bring about secure mounting of the relatively elastic polyurethane ring in a groove in the surrounding block.

### THE OBJECT OF THE INVENTION

One object of the present invention is to produce sealing rings for piston rods and pistons, in which inter alia the risk of detrimental friction heating and gap extrusion has been eliminated or greatly reduced.

This makes it possible inter alia for the sealing rings to be mounted without separate support rings, which makes manufacture, mounting and maintenance of the seals considerably easier and less expensive.

The invention is based on the knowledge that this aim can be achieved by manufacturing a sealing ring by injection-molding two materials with different properties, so that a core made of one material is obtained, which is surrounded by a thin layer of another material with in part other properties.

In this connection, the inner material is to be sufficiently elastic in order to give the sealing ring the dynamic properties which are required for good flexibility and sealing action. This inner core material is surrounded by a thin layer of an outer material with low friction, which inter alia reduces friction heating of the seal material. Such heating otherwise reduces the rigidity of the seal material, which increases the risk of gap extrusion. In order further to reduce this risk, the outer layer can be made of a harder material than the core.

It is then, according to the present invention, especially characteristic of a method of the type indicated in the first paragraph that the sealing ring is manufactured by simultaneous injection-molding of two materials with different properties, so that it has an inner core made of a first material with first properties and an outer layer made of a second material with in part second properties surrounding the core, and so that said sealing surface is at least partly formed by a part of said outer layer with said second properties.

By means of this method, it is possible to produce a sealing ring with lower friction heating of the seal material, which in itself reduces the risk of gap extrusion. The material in the outer layer can also be selected so that the tendency toward gap extrusion is, further reduced.

The sealing ring is preferably manufactured by the two materials being injected sequentially into a mold, said second material being injected into the mold first, after which said first material is injected centrally into the mold, so that it forces the second material injected first out against the delimiting surfaces of the mold cavity. Alternatively, the two materials can be combined in a unit located ahead of the mold, such as a plasticizing chamber or a nozzle, before they are injected together into the mold cavity. In both cases, it is possible to obtain a core made of the first material, which is surrounded by an outer layer of essentially uniform thickness made of the second, harder material.

It is preferred that, as said second material, a material is injected which gives lower friction on contact with a component bearing against it than the first material, the second material preferably having a greater hardness than the first material.

The materials can be injected into a mold which produces a dish-shaped blank, the peripheral outer edge portion of the blank being essentially V-shaped or U-shaped with two sealing lips for forming a pressure seal for a piston rod or the like, the sprue dish being cut away, so that the other end of the annular product obtained is shaped to form a piston rod wiper lip.

By means of this method, a combined wiper and pressure seal is therefore produced, which can be both manufactured and mounted in a single corresponding operational step without the use of separate support rings or the like.

The especially characteristic features of an elastic sealing ring manufactured according to the present invention emerge from the patent claims below.

The invention will be described in greater detail below with reference to the embodiments shown by way of example in the accompanying drawings.

### BRIEF DESCRIPTION OF THE DRAWING FIGURES

FIG. 1 illustrates known art for sealing a hydraulic piston with a piston rod.

FIG. 2 shows a part of a blank for a wiper according to the present invention.

FIG. 3 shows a part of a blank for a piston rod seal according to the invention.

FIG. 4 shows a part of a blank for a combined piston rod seal and wiper according to the invention.

FIG. 5 illustrates the sealing of a hydraulic piston with a piston rod using sealing rings according to the invention.

### DETAILED DESCRIPTION OF PREFERRED EMBODIMENTS

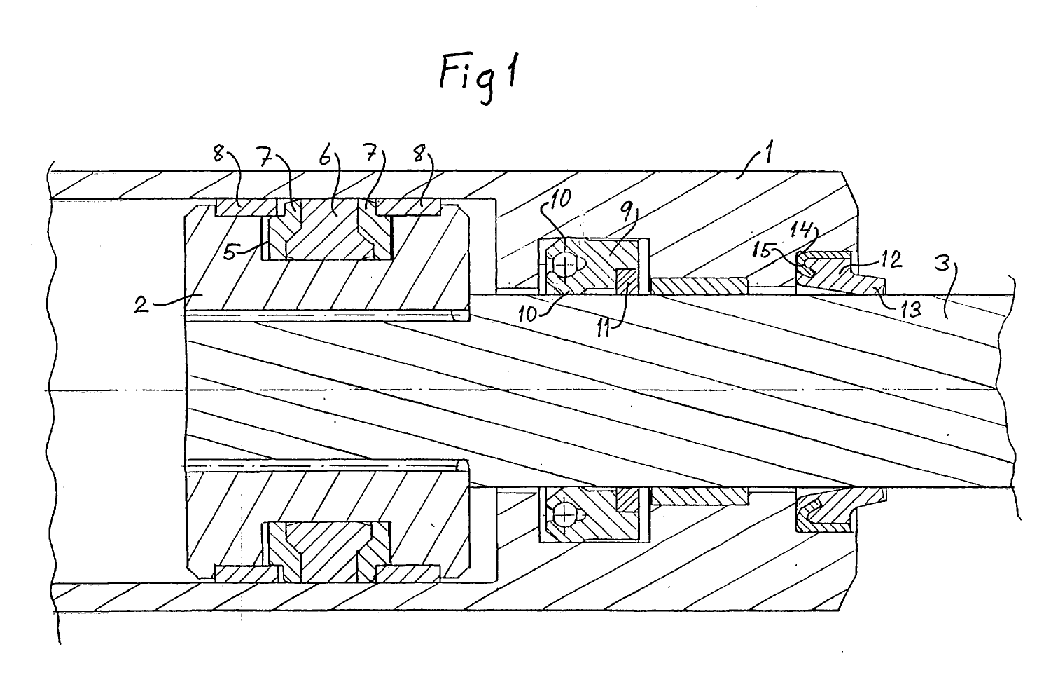

In FIG. 1, which shows known art, reference number 1 designates a cylinder block and 2 a piston which is displaceable in the block and has a piston rod 3 projecting through the end wall of the block. The piston 2 is provided with an elastic sealing ring 6 made of an elastomer, suitably a polyurethane material, arranged in a groove 5. To bring about the necessary sealing, the polyurethane material must be relatively soft, which involves risks of gap extrusion, that is to say the risk that the seal material will be pressed into and crushed in the gap between the piston 2 and the surrounding cylinder block 1. For this reason, the sealing ring 3 is supported on both sides by means of a pair of support rings 7 made of hard plastic material. Reference number 8 designates two guides for keeping the piston 2 centered in the cylinder.

The piston seal therefore consists overall of a number of components which have to be manufactured and mounted separately, which increases costs. The relatively soft material in the sealing ring 6 also results in increased friction which inter alia increases friction heating etc. All in all, this increases the risk of the seal material being damaged on account of friction heating.

Reference number 9 designates a so-called U packing ring which forms a pressure seal in order to prevent hydraulic oil from being pressed out from the cylinder along the piston rod 3. The pressure seal has two sealing lips 10 which will be pressed apart by the hydraulic pressure and then bring about good sealing of the piston rod 3. For this reason, the pressure seal 9 also has to be made of a relatively soft seal material with the attendant risk of detrimental friction heating. Furthermore, a support ring 11 is required in order to reduce the risk of gap extrusion as mentioned above.

Reference number 12 relates to what is known as a piston rod wiper with an annular wiper lip 13 bearing against the piston rod 3. This prevents dirt and other impurities from accompanying the piston rod into the hydraulic cylinder. To function well, the wiper 12 also has to be manufactured from a relatively soft seal material. On mounting in an open groove 14 in the cylinder end wall, a sheet-metal surround 14 is usually embedded in the wiper, which can be pressed firmly into the groove 14 by means of a press fit.

In order inter alia to avoid the high friction of previously used sealing rings manufactured from a soft seal material throughout with the attendant friction heating and risk of gap extrusion, sealing rings for inter alia piston rod wipers, piston rod seals and piston seals are manufactured according to the present invention by double injection of two plastic materials with in part different properties. In this way, it is possible to produce sealing rings with an outer layer with relatively low friction in order inter alia to reduce friction heating and the risk of gap extrusion, and with a softer inner core which gives the sealing ring the necessary flexibility and adaptability so as to provide good sealing action. In order further to reduce the risk of gap extrusion, the outer layer is made of a harder material than the core.

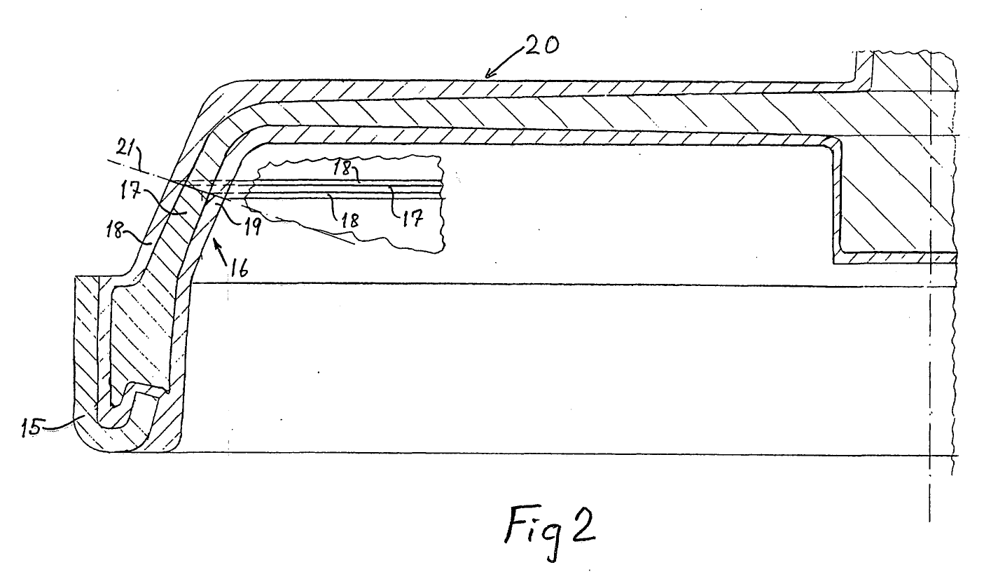

FIG. 2 shows a section through one half of a dish-shaped blank, produced in a mold by double injection, for a piston rod wiper 16 according to the present invention. The blank has an inner core 17 made of a relatively elastic seal material, for example of polyurethane with a hardness of 40-70° Shore D, preferably roughly 50-60° Shore D. The core 17 is surrounded by a relatively thin outer layer 18 with a thickness of the order of 0.2-0.6 mm, preferably roughly 0.4 mm. The outer layer also suitably consists of a polyurethane material which, however, is harder than the material in the core 17 and has a hardness of the order of 85-95° Shore D, preferably roughly 90-93° Shore D. This harder outer layer results in low friction against the piston rod and thus low friction heating as well. On account of the softer core 17, however, good flexibility and adaptability of the sealing ring are obtained for maintaining a good sealing function.

The blank shown is manufactured by simultaneous injection-molding of the two plastic materials. This can be carried out by sequential injection of the two plastic materials into a mold. In this connection, the harder material, which is to form the outer layer 18 of the sealing ring, is injected first. Then, the material for the core 17 is injected centrally into the mold, this material, when injected, forcing the material injected first out against the delimiting surfaces of the mold cavity, so that the latter material will form an outer layer 18 which surrounds the softer material in the core 17.

If the wiper is to be provided with a sheet-metal surround 15, such a surround is positioned in the mold before the plastic materials are injected, so that it will be molded integral with the outer layer 18.

After mold removal, the sprue dish 20 formed is cut off along an angled cutting line 21, so that a cut surface as illustrated in the figure is obtained. The outer layer 18 on the inner surface of the ring will then form a sealing lip 19 which bears against a piston rod which is guided through the sealing ring. This means that it is the harder material in the outer layer 18 which bears against the piston rod, which results in reduced friction and thus reduced friction heating in comparison with previously known wipers. The flexibility of the wiper lip 19 will be retained, however, on account of the softer material in the core 17 of the wiper ring.

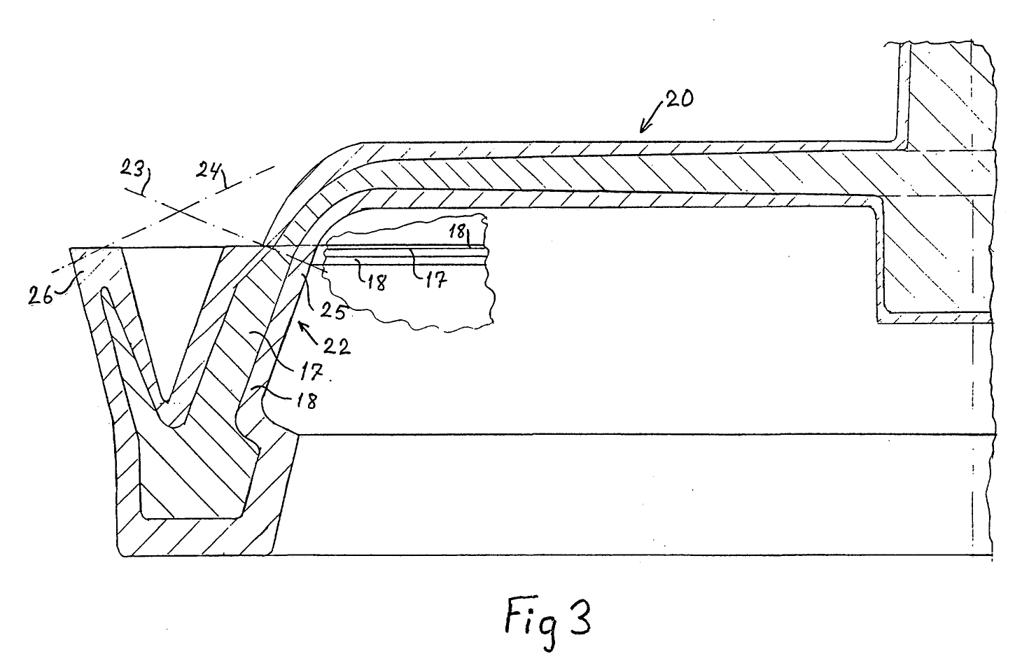

FIG. 3 illustrates in a corresponding manner one half of a blank for a piston rod seal 22 after mold removal. As in FIG. 2, the blank consists of a core 17 made of a soft plastic material, which is surrounded by an outer layer 18 made of a harder material. The sprue dish 20 is cut away, and the two end portions of the V-shaped sealing collar are chamfered along the lines 23 and 24. In this way, a sealing lip 25 with the cross section shown bearing against a piston rod guided through the collar, and a sealing lip 26 bearing against the bottom in a groove in a surrounding cylinder end wall are formed.

The pressure from the hydraulic oil in the cylinder will penetrate the V shape between the sealing lips 25 and 26 and press these away from one another to bear in a sealing manner against the piston rod and, respectively, the cylinder block. In both cases, the bearing part of the sealing lip consists of the outer harder material 18, but the sealing lip still has good flexibility on account of the inner, softer core 17.

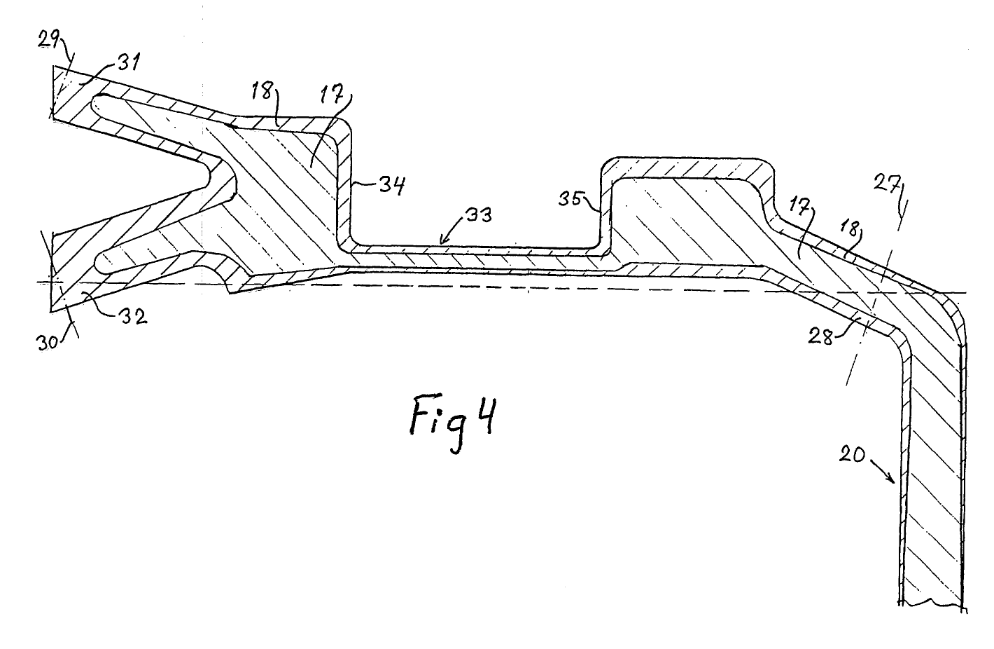

FIG. 4 illustrates a blank for a combined piston rod wiper and piston rod seal. As previously, the blank is constructed from a relatively flexible core 17 and a harder outer layer 18. The sprue dish 20 is cut off along a cutting line 27 to form a piston rod wiper lip 28, as described above in connection with FIG. 2. At the other end, the end portions of the blank are chamfered along the lines 29 and 30 to form sealing lips 31 and 32 for bearing against a surrounding cylinder block and, respectively, a piston rod.

The part serving as the piston rod wiper is connected to the part serving as the piston rod seal via a relatively thin portion 33 which barely fills the gap present between the piston rod and the cylinder end wall. This portion and the shoulder surfaces 34 and 35 delimiting it make it possible for the combined seal and wiper to be anchored securely in the cylinder block. On account of the hard material in the outer layer 18, the risk is also eliminated of the seal material in the piston seal penetrating the gap between the piston and the cylinder end wall, which is also to a great extent filled by the material portion 33.

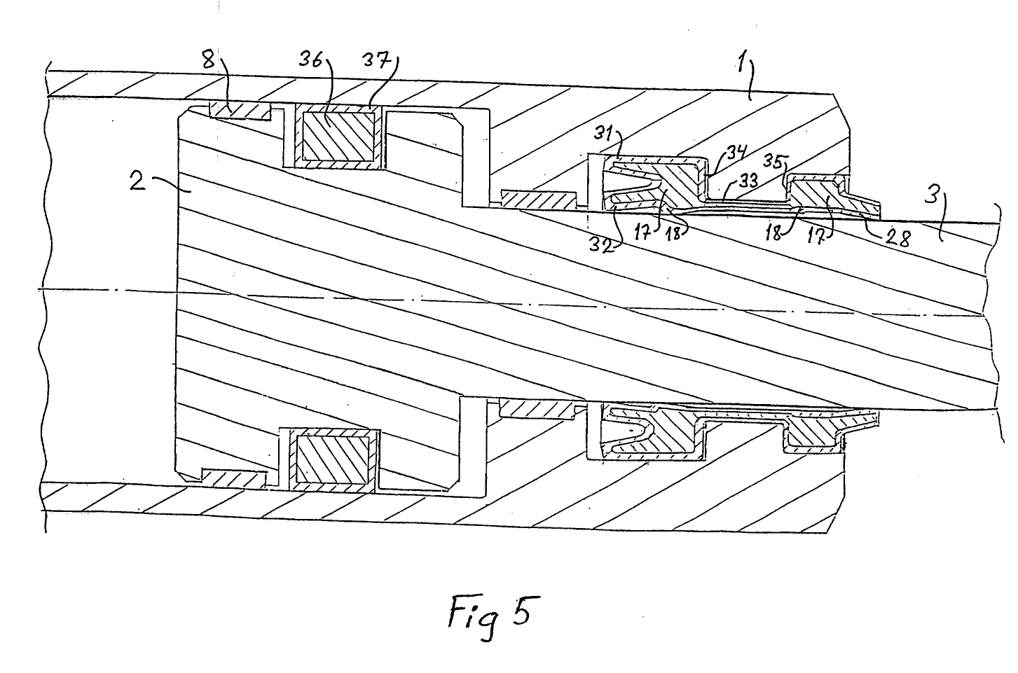

The fitting of the combined seal shown in FIG. 4 can be seen in FIG. 5 which, shows the application of sealing elements according to the invention in a hydraulic cylinder of the same type as is shown in FIG. 1.

As previously, the reference numbers 1, 2 and 3 relate to a cylinder block, a piston and, respectively, a piston rod which projects through the cylinder block. The reference numbers 8 relate to guides for the piston 2 and the piston rod 3.

Arranged between the end wall of the cylinder block 1 and the piston rod 3 is a combined sealing element according to FIG. 4. This comprises a wiper lip 28 which bears against the piston rod 3, and a piston rod seal with a sealing lip 32 for bearing against the piston rod 3 and a sealing lip 31 for bearing against the bottom surface of a groove in the cylinder end wall. The sealing lips 31 and 32 are pressed away from one another on account of hydraulic oil entering the V-shaped space between these sealing lips.

By virtue of the fact that the sealing element according to the above is manufactured with a softer core and a harder outer layer, a sealing element is obtained with low friction and low friction heating but which still has the necessary flexibility for bringing about good sealing action. Manufacture and mounting are made easier and less costly, as it is necessary to handle only one element without a requirement for extra support rings or equivalent.

In the same way, the piston seal is made with a softer core 36 and a harder outer layer 37. This affords the same advantages as indicated in connection with the piston rod seal and means that no extra support rings for preventing gap extrusion are required. This means lower costs for the piston seal as well, as inter alia separate support rings do not have to be manufactured, mounted or maintained.

Another advantage is that sealing rings according to the invention can be made in undivided form, as the elasticity is sufficient for it to be possible for these to be pulled onto, for example, a piston or a piston rod. The support rings used previously had to be mounted in sections as they were too inelastic to be slipped onto, for example, a piston.

The lower friction of the outer layer results in itself in a reduced risk of gap extrusion on account of lower friction heating and thus a smaller reduction in the rigidity of the material. In this connection, the outer layer can consist of the same material as the core but with an addition of a friction-reducing substance, such as Teflon powder.

The invention has been described above in connection with the embodiments shown in the drawings. It can, however, be varied in a number of respects within the scope of the patent claims below. The technique described can therefore also be used for other sealing rings with other configurations and intended for other applications than those described above. The necessary modifications can then be performed easily by a person skilled in the art. In this connection, the material combinations can also be changed if so desired or required, and the indicated material thicknesses and hardnesses can be varied depending on the circumstances.

1. A method for manufacturing an elastic sealing ring for sealing between a displaceable and/or rotatable component, such as a piston, piston rod, shaft etc., and a surrounding component, such as a cylinder block, a cylinder end wall etc., which sealing ring is adapted so as to be mounted in a groove in one component and has at least one sealing surface intended for bearing against the other component, characterized in that the sealing ring is manufactured by simultaneous injection-molding of two materials with different properties, so that it has an inner core made of a first material with first properties and an outer layer made of a second material with in part second properties surrounding the core, said sealing surface being at least partly formed by a part of said outer layer with said second properties.

2. The method as claimed in claim 1, characterized in that the two materials are injected sequentially into a mold, said second material being injected into the mold first, after which said first material is injected centrally into the mold, so that it forces the second material injected first out against the delimiting surfaces of the mold cavity.

3. The method as claimed in claim 1, characterized in that the two materials are first combined in a unit located ahead of the mold and are then injected together into the mold cavity.

4. The method as claimed in any one of claims 1-3, characterized in that, as said second material, a material is injected which gives lower friction on contact with a component bearing against it than the first material.

5. The method as claimed in any one of claims 1-4, characterized in that, as said second material, a material is injected which has a greater hardness than the first material.

6. The method as claimed in any one of claims 1-5, the materials being injected into a mold which produces a dish-shaped blank, characterized in that the peripheral outer edge portion of the blank is essentially V-shaped or U-shaped with two sealing lips for forming a pressure seal for a piston rod or the like, and in that the sprue dish is cut away, so that the other end of the annular product obtained is shaped to form a piston rod wiper lip.

7. The method as claimed in claim 6, characterized in that the annular product is shaped so that the thickness of the part which connects the two pressure seal lips to the piston rod wiper lip is relatively small.

8. An elastic sealing ring for sealing between a displaceable and/or rotatable component, such as a piston (2), piston rod (3), shaft etc., and a surrounding component, such as a cylinder block (1), a cylinder end wall etc., which sealing ring (16; 22) is adapted so as to be mounted in a groove in one component, has at least one sealing surface (19; 25, 26; 28; 31, 32) intended for bearing against the other component, and comprises two materials with different properties, characterized in that it is made with an inner injection-molded core (17) made of a first material with first properties and an outer layer (18) made of a second material with in part second properties and injection-molded together with the core, which second material is fused together with the material in the core in the boundary zone, and in that said sealing surface is at least partly formed by a part of said outer layer (18) with said second properties.

9. The sealing ring as claimed in claim 8, characterized in that said second material has lower friction on contact with a component part bearing against it than the first material.

10. The sealing ring as claimed in claim 8 or 9, characterized in that said second material has a greater hardness than the first material.

11. The sealing ring as claimed in any one of claims 8-10, characterized in that one end of the ring is essentially V-shaped or U-shaped with two sealing lips (31, 32) for forming a pressure seal for a piston rod (3) or the like, and in that the other end of the ring is shaped as a piston rod wiper lip (28).

12. The sealing ring as claimed in claim 11, characterized in that the thickness of that part (33) of the ring which connects the two pressure seal lips (31, 32) to the piston rod wiper lip (28) is relatively small.

13. The sealing ring as claimed in any one of claims 10-12, characterized in that the thickness of said outer layer (18) with the greater hardness is of the order of 0.2-0.6 mm, preferably roughly 0.4 mm.

14. The sealing ring as claimed in any one of claims 10-13, characterized in that said first material (17) has a, hardness of the order of 40-70° Shore D, preferably roughly 50-60° Shore D, and in that said second material (18) has a hardness of the order of 85-95° Shore D, preferably roughly 90-93° Shore D.
